(19) United States
(12) Patent Application Publication
(10) Pub. No.: US 2026/0104337 A1
(43) Pub. Date: Apr. 16, 2026

(54) CONTINUOUS INTERFACIAL FRACTURE STRENGTH TESTING TECHNIQUE

(71) Applicant: International Business Machines Corporation, Armonk, NY (US)

(72) Inventors: Sathyanarayanan Raghavan, Ballston Lake, NY (US); Qingyu Ben Yang, Los Altos, CA (US); Katsuyuki Sakuma, Fishkill, NY (US)

(21) Appl. No.: 18/914,408

(22) Filed: Oct. 14, 2024

(51) Int. Cl. G01N 3/32

(52) U.S. Cl. CPC G01N 3/32; G01N 2203/0066; G01N 2203/0067; G01N 2203/0236; G01N 2203/0641; G01N 2203/0682

(57) ABSTRACT

A test apparatus includes a stage configured to support a test piece; a crack propagating element (e.g., a blade) positioned in relation to the stage; and a deformation measuring element (e.g., profilometer) positioned above the stage. A processor is configured to control the stage and the deformation measuring element. In a method, such an apparatus is provided. A test piece is secured to the stage. The processor causes relative motion of the cleaving element towards the secured test piece for multiple insertions of the cleaving element into the secured test piece, until the secured test piece fractures. The processor causes measurement, with the deformation measuring element, of a vertical height along at least a portion of a length of the secured test piece, to determine, for the multiple insertions, a crack tip location in the secured test piece.

### BACKGROUND

The present invention relates generally to the electrical, electronic, mechanical, and computer arts, and, more particularly, to fracture strength testing, such as for semiconductor devices, including bonded wafers.

Characterization of fracture strength can occur via a razor blade test. A common method is to move a razor blade between two bonded samples and infrared (IR) light is directed from the top, for analysis of a resulting fracture between the bonded samples. Although IR systems can be used to determine crack length needed for estimating the fracture strength, these IR measurement systems have their limitations due to limited resolution (e.g., 0.5 mm). Further, current IR measurement systems do not provide continuous insertion of the razor blade and measurement of the fracture strength from starting to the end of the sample.

### BRIEF SUMMARY

Principles of the invention provide continuous interfacial fracture strength testing techniques.

In one aspect, an exemplary apparatus includes a stage configured to support a test piece; a crack propagating element positioned in relation to the stage; a deformation measuring element positioned above the stage; and a processor configured to control the stage and the deformation measuring element.

In another aspect, an exemplary method includes providing an apparatus comprising: a stage; a cleaving element positioned in relation to the stage; a deformation measuring element positioned above the stage; and a processor configured to control the stage, the cleaving element, and the deformation measuring element. Further steps include securing a test piece to the stage; the processor causing relative motion of the cleaving element towards the secured test piece for multiple insertions of the cleaving element into the secured test piece, until the secured test piece fractures; and the processor causing measurement, with the deformation measuring element, of a vertical height along at least a portion of a length of the secured test piece, to determine, for the multiple insertions, a crack tip location in the secured test piece.

In still another aspect, a computer program product is provided for controlling an apparatus comprising: a stage; a cleaving element positioned in relation to the stage; a deformation measuring element positioned above the stage; and a processor configured to control the stage, the cleaving element, and the deformation measuring element. The computer program product includes one or more computer-readable storage media; and program instructions stored on the one or more computer-readable storage media to perform operations comprising: causing relative motion of the cleaving element towards the secured test piece for multiple insertions of the cleaving element into the secured test piece, until the secured test piece fractures; and causing measurement, with the deformation measuring element, of a vertical height along at least a portion of a length of the secured test piece, to determine, for the multiple insertions, a crack tip location in the secured test piece.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor and/or by test equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
Usage of profilometer positioned above a top surface of a stack of layers (e.g., wafers) for improved accuracy for measuring fracture strength for the layers (e.g., silicon layers); the fracture strength can be determined based on measured deformation of a propagated fracture induced by movement of a razor blade between the layers;
Improved detectability of fracture strength for bonds allowing for rapid batch processing of wafers and the like;
Multiple insertions of the razor blade allow for continuous measurement of interfacial fracture strength across a length of a sample (e.g., the stack of layers, the wafers) that may vary in shape and/or size (i.e., the sample is not limited to a rectangular sample);
Robust technique to measure interfacial fracture strength from wafer edge to wafer center; and
Temperature and humidity can be controlled accurately to study the impact of these parameters on fracture strength.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a system for determining crack length in a test sample;

FIG. 2 illustrates insertion of a cleaving element into the test sample;

FIG. 3 illustrates continued movement of the cleaving element to a center of the test sample;

FIG. 4A illustrates preparation of the test sample;

FIG. 4B illustrates a cross-section of the test sample;

FIGS. 4C-4F illustrate insertion of the cleaving element into the test sample and movement to the center of the test sample;

FIGS. 5A-5C illustrate insertion of the cleaving element into the test sample, movement to the center of the test sample and usage of the deformation measuring element;

FIG. 6 illustrates an operative flow chart;

FIG. 7 illustrates a first insertion profile of the cleaving element into the test sample;

FIG. 8 illustrates subsequent insertion profiles of the cleaving element into the test sample;

FIG. 9 illustrates the vertical displacement (z) along length of the sample (x) on the top surface of the test sample;

FIG. 10 illustrates the derivative (slope) of z (vertical displacement after blade insertion) with respect to x;

FIG. 11 illustrates normalized surface energy vs. insertion distance; and

FIG. 12 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

As noted, there is a challenge in precisely measuring fracture strength, such as at the bond interface of two hybrid-bonded wafers. Advantageously, one or more embodiments overcome the drawbacks of the prior art by providing continuous interfacial fracture strength testing techniques. Embodiments can include, for example, a stage that moves horizontally, a measurement system based on white light interferometry, a humidity controller, a processor, a memory storing instructions to configure the processor, and a monitor.

In general, hybrid bonding is a bonding process that combines both dielectric and metal bonding to form interconnections. In hybrid bonding, a permanent bond combines a dielectric bond (e.g., SiOₓ) with embedded metal (e.g., Cu) to form interconnections. Two interconnect structures or semiconductor builds are joined together (e.g., two individual wafers that are built separately). They typically require a “pristine” surface (smooth and flat, possibly with some recesses), more so than traditional chemical-mechanical planarization (CMP). The two semiconductor builds are purposely designed to align. The term “hybrid” refers to the modification of the dielectric bonds and creation of fusion bond between metal pads at the same time during annealing step. Two wafers are aligned and placed on top of each other at room temperature. It is followed by a heat treatment/annealing process. During the annealing step, the oxides bond strength increases and the metals pads fuse together, thus joining parts together (in some instances, seamlessly; i.e., the interface line disappears).

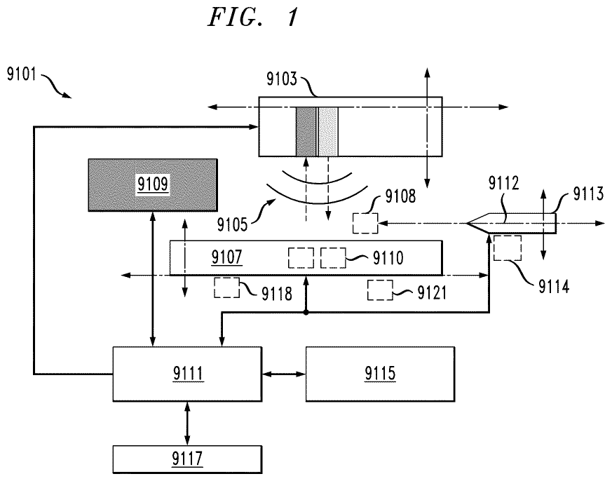

FIG. 1 illustrates a system 9101 for measuring fracture strength in bonded wafers (e.g., oxide to oxide layers) used for semiconductors, or for other bonded samples. The system 9101 includes a deformation measuring element 9103 (e.g. contact based profilometer probe, non-contact profilometer such as optical profilometer (laser based or chromatic white light system, or the like). The deformation measuring element 9103 can, for example, direct a white light 9105 to a top surface of the sample (e.g., bonded wafers) and measure surface height on 3D structures of the sample with surface profiles varying between tens of nanometers and a few centimeters based on white light interferometry. Often used as an alias for coherence scanning interferometry in the context of white light-dependent surface profilometers. The deformation measuring element 9103 is positioned above the sample, and the sample is positioned on a stage 9107. The deformation measuring element 9103 can measure the Z-directional shift of the object (e.g. topmost of the two bonded wafers) surface using a white light interferometry measurement method as the cleaving element 9113 (e.g., a razor blade) moves through the wafer. The stage 9107 can include, by way of a non-limiting example, a length and width to support samples such as bonded pieces of a wafer or wafers; such samples can have, by way of example and not limitation, a length (e.g., with a lower limit of length of 50 mm or 90 mm, and an upper limit of length of 150 mm or 200 mm or 300 mm) and a width (e.g., with a lower limit of width of 1 mm or 2 mm and an upper limit of width of 4 mm or 5 mm or 10 mm).

An alignment mechanism 9108, such as, for example, a known stepper used in semiconductor processing, a screw thread, a servo, a solenoid, a pneumatic system, a hydraulic system, gears, or the like, can align the bonded samples with the cleaving element 9113; the sample and/or the blade can be moved to facilitate vertical alignment. The speed of movement of the stage and/or the razor blade (e.g., insertion speed) can be controlled with the stepper or other mechanism (for example, the speed of a screw-thread actuated system can be determined by number of threads per unit length, RPM, and so on). The stage 9107 can also be controlled to move horizontally and/or vertically (x, y, z). Rotation of the sample can occur using automated or manual techniques. For example, there can be reference marks on the sample and the stage to determine rotation (e.g., a reference mark on stage and angular indexing marks on the wafer periphery). The sample can be positioned and vacuum can be applied to secure it when it is properly located.

Note that cleaving element 9113 can, for example, be a commercially available single-edge razor blade, and is a non-limiting example of a fracture-inducing probe (which can include other types of blades, wedges, and the like, for example). A heater 9121 can be used to heat the environment (e.g., the stage 9107 can be heated or the air around the sample can be heated). The heater 9121 can be coupled to the processor 9111 for control. Contact heaters could include, for example, nichrome films or wires, cartridge heaters, or the like. When the air is heated, the sample is allowed to equilibrate thermally. Measurements are taken at different temperatures as measured by a thermocouple/thermistor or the like. Generally, any of the disclosed components can be mounted using known mounting techniques as appropriate for the component of interest such as mounting brackets and the like.

Note that instead of a white-light optical profilometer, other types of profilometer could be used in some cases, such as a contact/stylus profilometer.

A mechanism 9114, such as a known stepper used in semiconductor processing or similar elements discussed above, can move a tip 9112 of the cleaving element 9113 gradually (on the order of m/s to mm/s) toward the center of the wafer in a horizontal direction. Mechanism(s) 9110 (e.g., mechanical fasteners, vacuum, or the like) can secure a wafer to the stage 9107. The white light interferometry method using the white light 9105 allows for vertical resolution of the sample down to 3 nm, in a non-limiting example. Generally, given the teachings herein, the skilled artisan can select available components with available accuracy and resolution suitable to a given task.

In one or more embodiments, the deformation measuring element 9103 makes measurements that can be used to determine fracture length. In one or more embodiments, the system 9101 also includes a humidity controller 9109 for controlling humidity in the testing environment—examples include dehumidifiers that run on a refrigeration cycle, humidifiers that evaporate water vapor into the air, desiccant systems, controlled by a digital or analog hygrometers and a processor, and the like. Values of γ will depend based on the humidity one or more embodiments are accordingly enabled to perform humidity control to whatever specifications are needed. A processor 9111 controls the system 9101 and is in communication, for example, with the deformation measuring element 9103, the stage 9107, the cleaving element 9113, memory 9115, and/or a monitor 9117 for displaying results of the testing, and the other mechanisms for operating the system 9101. See FIG. 12 and accompanying text.

The processor 9111 can determine/extract razor blade insertion profiles. The insertion profiles can be stored in the memory 9115. The memory can be configured to store instructions for operating the system 9101. The processor 9111 controls movement of the stage 9107 and movement (e.g., horizontal and/or vertical) of the cleaving element 9113. The processor 9111 also controls the deformation measuring element 9103 and the humidity controller 9109. A mechanism 9118, such as a known stepper used in semiconductor processing or similar elements discussed above, can be used to move the stage 9107 horizontally and/or vertically.

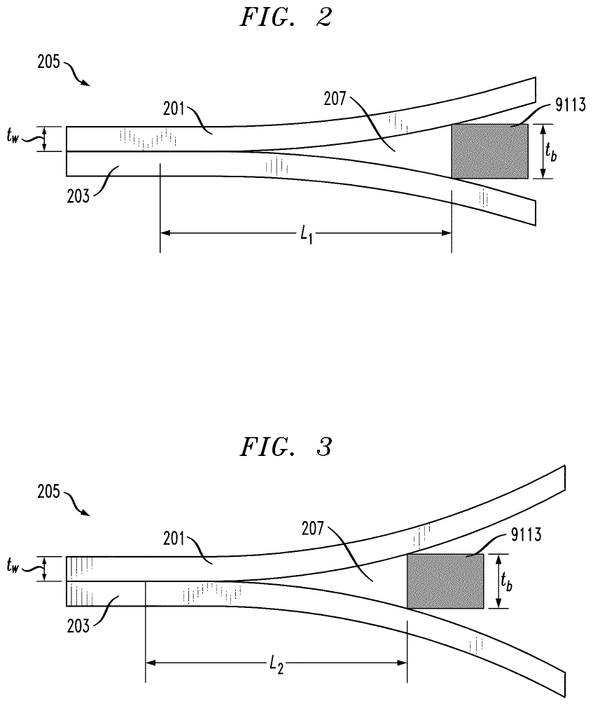

FIG. 2 illustrates a first insertion of the cleaving element 9113 between a wafer 201 and a wafer 203. Note fracture 207. The parameter t_{w} is wafer thickness; t_{b} is blade thickness; E is modulus of elasticity (Young's modulus); and L₁ is fracture length corresponding to the given insertion “1” and generally “L” in the following equation. Fracture strength (γ) can be calculated by Equation 1, for the case when both boded samples have the same wafer material, thickness, and width. Note bonded wafers 205 including wafers 201 and 203. With the benefit of this disclosure, a skilled artisan could derive equations for other geometries and/or could perform finite element analysis to determine fracture strength of irregular geometries.

$$γ = \frac{3 {t}_{b}^{2} {Et}_{w}^{3}}{32} {L}^{- 4} \qquad Eq . ( 1 )$$

FIG. 3 illustrates a second insertion of the cleaving element 9113 between the wafer 201 and the wafer 203. Note the fracture 207. L₂ is fracture length corresponding to the given insertion “2”. As noted above, the fracture strength (γ) can be calculated by Equation 1. Note that the fracture extends beyond the end of the blade.

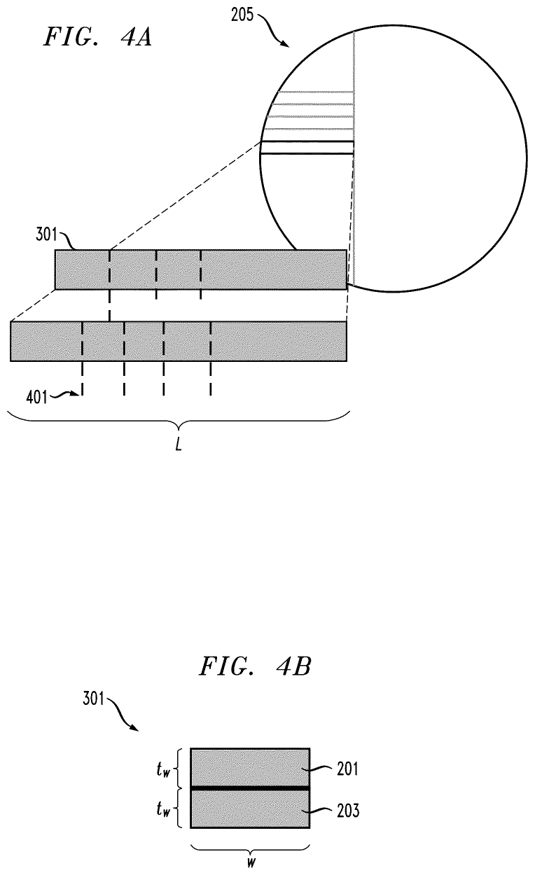

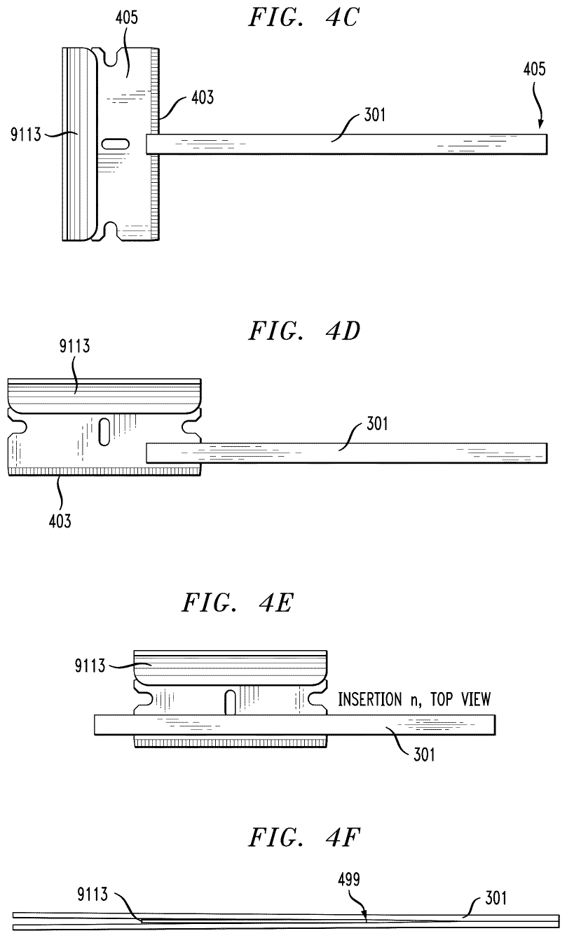

Consider now an exemplary process flow shown in FIGS. 4A-4F. As shown on FIG. 4A, a bonded wafer 205 is provided. The wafer 205 can be diced into multiple strips with multiple (e.g., three) passes through the thickness of the wafer 205. Note multiple insertions 401 (e.g., 1 through 4 as per the dashed lines) performed with the cleaving element 9113. The wafer 205 (bonded wafer) can be diced into strips 301 (e.g., 4 mm width w, thickness t_{w} of 0.775 mm, and a length of 95 mm), it being understood that different sizes, and even different methods of sample preparation, can be used in other embodiments. Note the length L. Dimensions of the samples can be different from the examples, and in the cases of bonded samples, the bonded pieces can be the same or different materials and can have the same or different dimensions. For instance, thicknesses and/or lengths and/or widths can be different.

With additional reference to FIG. 4B, a cross-section of a strip 301 is shown. Note the width w and the thicknesses t_{w} of the wafer 201 bonded to the wafer 203 of the strip 301. The strip 301 can be wiped with alcohol. Then, a fracture can be initiated in the strip 301 and measured, and then the fracture can be propagated with the razor and measured again. The fracture can be propagated until the wafer 201 and the wafer 203 in the strip 301 are completely separated and are no longer bonded together. In the case of bonded samples, bonds can be die-to-die, wafer-to-wafer, die-to-wafer, die to coupon, or others. Generally, there can be the same or different values of x, y, t, etc. FIG. 4B shows equal width and thickness but either or both can differ.

FIG. 4C illustrates a top view of initiating a fracture with an edge 403 of a razor 9113. Note the strip 301 and the end region 405 of the strip 301. The edge 403 of the cleaving element 9113 can be parallel to the stage 9107. Note the body 405 of the cleaving element 9113.

FIG. 4D illustrates a top view of fracture propagation with the side of the razor 9113. Note the strip 301.

FIG. 4E illustrates a top view of continued fracture propagation with the side of the cleaving element 9113. Note the strip 301. At least one insertion after the initial insertion can occur (e.g., insertion n).

FIG. 4F illustrates a side view of the fracture propagation. Note the strip 301 and the cleaving element 9113, and the crack start 499.

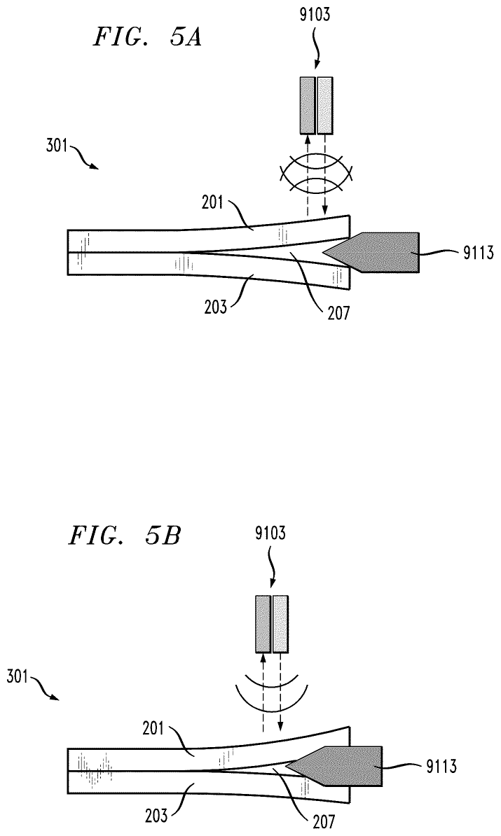

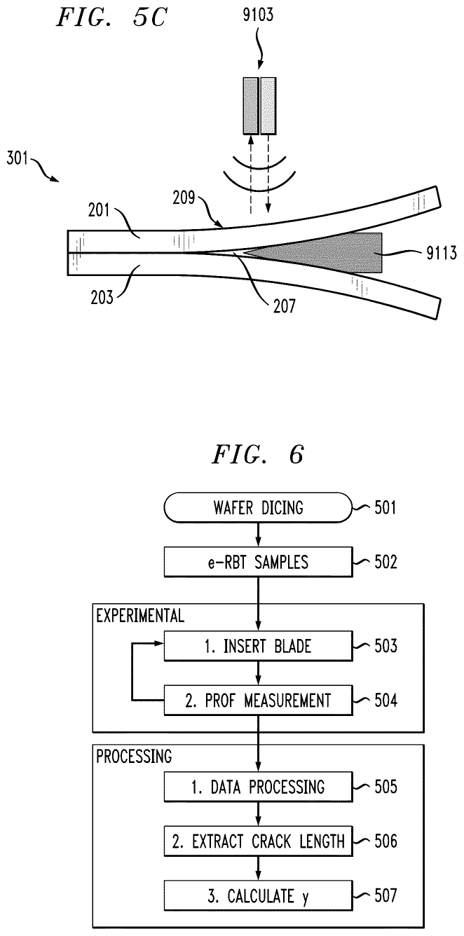

Consider now an exemplary process flow shown in FIGS. 5A-5C. FIG. 5A illustrates a first position for the cleaving element 9113 that has initially engaged the strip 301 between the wafer 201 and the wafer 203 of the strip 301. Note the fracture 207 and the deformation measuring element 9103.

FIG. 5B illustrates a second position for the cleaving element 9113 that has moved along a length of the strip 301 between the wafer 201 and the wafer 203. Note the fracture 207 and the deformation measuring element 9103.

FIG. 5C illustrates a third position for the cleaving element 9113 that has moved towards a center 209 of the strip 301 between the wafer 201 and the wafer 203. Note the fracture 207 and the deformation measuring element 9103.

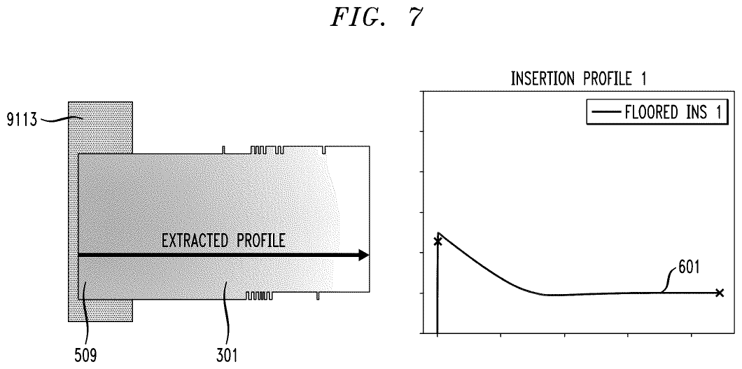

FIG. 6 illustrates a process flow in accordance with an embodiment of the present disclosure. At step 501, the wafer 205 is diced. At step 502, extended razor blade test (e-RBT) samples (e.g., the strips 301) are provided. At step 503, the razor blade (e.g., the cleaving element 9113) is inserted into the sample (e.g., the strip 301). At step 504, at least one metrology (e.g., profilometer) measurement is performed. At step 505, data for determining fracture length is processed. A tip of the crack length is measured and used for determining fracture strength via Eq. 1, for example. Analysis for a tip of the crack and blade position can be based on at least FIGS. 7, 8, and 10. The profilometer is used to measure crack/fracture lengths with an accuracy of ±10 μm and γ±0.0025 J/m². At step 506, the fracture (i.e., a crack) length is extracted. At step 507, the fracture strength (γ) is calculated.

A non-limiting example of a suitable profilometer is the FRT MicroProf® TL optical surface measurement tool available from Camtek Ltd., Ramat Gavriel Ind. Zone, Migdal Ha'emek Israel.

It is worth noting that, in a non-limiting example, the thicknesses and Young's modulus are known. The value of L for each insertion can be determined from profilometer measurements.

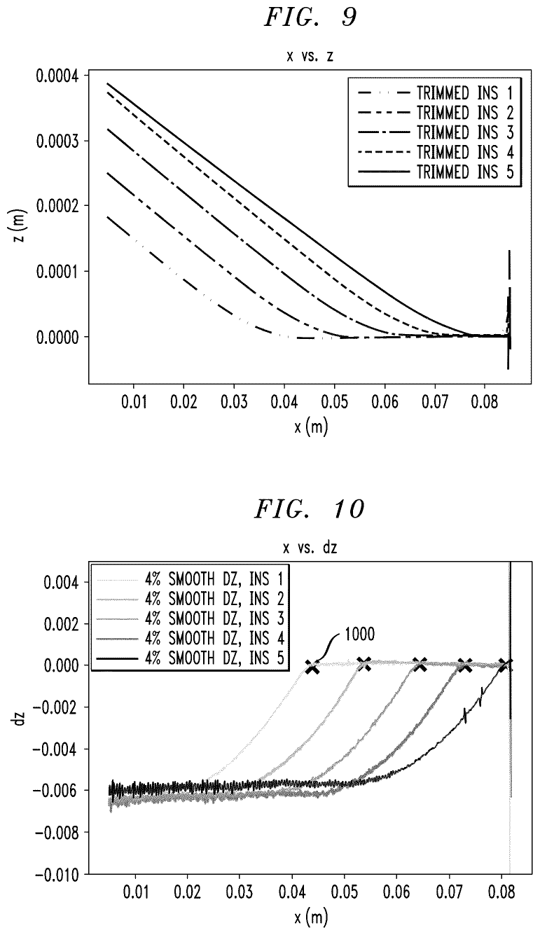

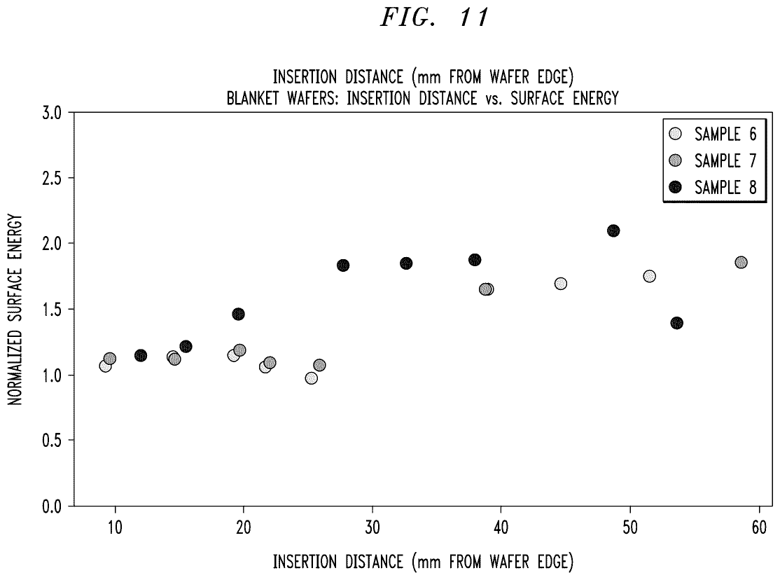

Specifically, looking at FIG. 9, obtain Z as a function of X. Carry out, for example, numerical differentiation to obtain, e.g., FIG. 10. The crack tip is located where the slope goes to zero, such as by the bold “X” 1000 for each trial. The length is then the difference between the blade edge and crack tip, as seen in FIGS. 2 and 3.

FIG. 7 illustrates a first insertion profile 601 for the cleaving element 9113 positioned at an edge 509 of the strip 301. Extraction of fracture data can initially start with a 2-dimensional (2D) heatmap (element 301 represents both the sample and the heatmap). Note the cleaving element 9113 and the sample (strip 301). The cleaving element 9113 is at a lower plane (at the interface) and a focus is in the top surface of the bonded sample. As seen, the cleaving element 9113 is inserted from one end and the typical distortion profile is shown in the heat map. From this heat map, position of the blade can be determined as well. The cleaving element 9113 is “darker” than the strip 301 in the heatmap.

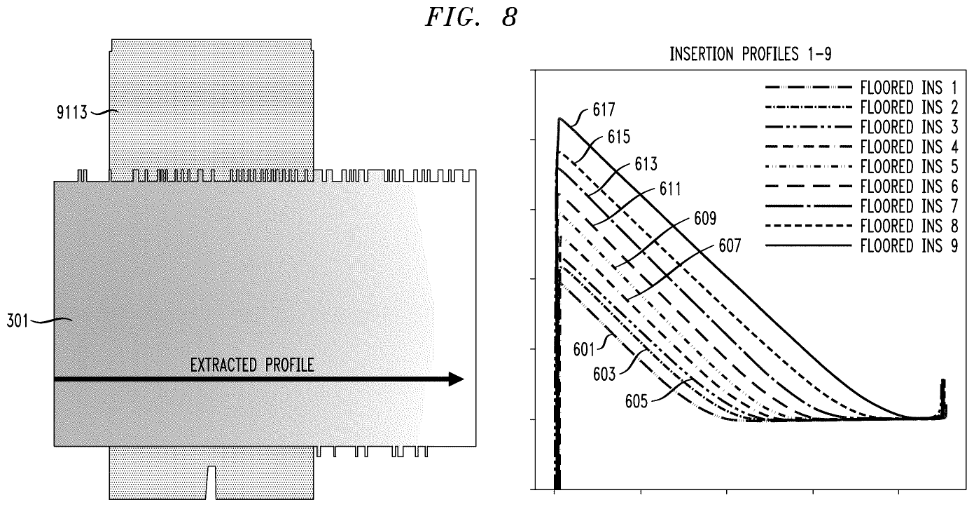

FIG. 8 illustrates the first insertion profile 601 for the cleaving element 9113 positioned in the strip 301, as well as a second insertion profile 603, a third insertion profile 605, a fourth insertion profile 607, a fifth insertion profile 609, a sixth insertion profile 611, a seventh insertion profile 613, an eighth insertion profile 615, and a ninth insertion profile 617.

FIG. 9 illustrates the vertical displacement (z) along length of the sample (x) on the top surface of the sample, as the blade is inserted from position 1 to position 5 gradually moving deeper along the length of the sample. It can be seen that the maximum vertical displacement increases with each insertion.

FIG. 10 illustrates the derivative (slope) of z (vertical displacement after blade insertion) with respect to x. It can be observed that there is a constant negative slope, which flattens to a zero slope region at the corresponding bold “X” (end of the crack, represented by reference 1000). Where the sample transitions from the varying slope to zero slope indicates the crack tip. The distance between the crack tip and the tip of the blade is the crack length required for determining the fracture strength. The crack tip is represented by a blade position to X.

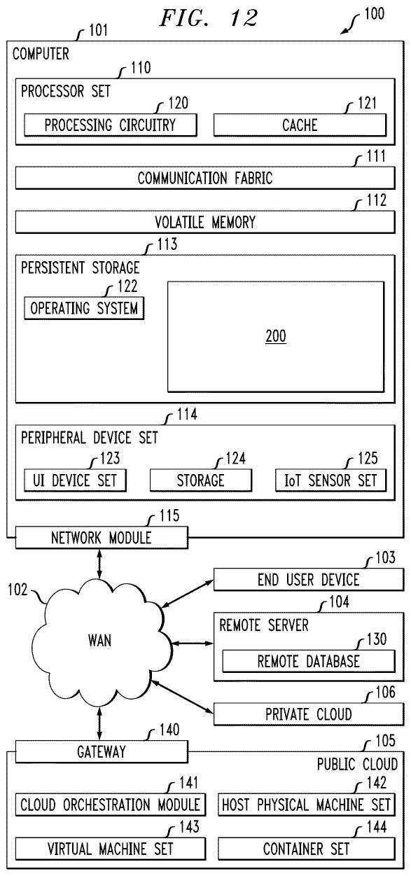

FIG. 11 illustrates insertion distances vs. normalized surface energy, for blanket wafers. In this case, it can be seen that the fracture strength for this particular sample is higher at center of wafer compared to the edges. Thus, this method is capable of capturing spatial variation in fracture strength, γ. In other cases, γ might remain constant or vary randomly based on the processing steps and this method can effectively capture the variations. The values are normalized to 1 based on a pass-fail criterion; i.e., a value above 1 is passing, and a value below 1 is failing.

One or more embodiments include an apparatus comprising a stage 9107 that moves horizontally, a white light interferometry measuring element 9103, a humidity controller 9109, a processor 9111, a memory 9115 storing instructions, and a monitor 9117. One or more embodiments include a mechanism to fix the bonded Si wafer 205 and/or bonded Si pieces/dies (e.g., strips 301) to the stage 9107. One or more embodiments include the stage 9107 that has a structure that is sized to place Si pieces or wafers from a few (e.g., 3 mm) millimeters to 300 millimeters. One or more embodiments include a mechanism 9108 to align the tip of the cleaving element 9113 with the bonding interface. One or more embodiments include a mechanism 9114 that moves the tip of the cleaving element 9113 gradually (μm/s to mm/s) toward the center 209 of the strip 301 with μm accuracy in a horizontal direction. One or more embodiments include a structure that allows the cleaving element 9113 to be moved toward the center 209 of the object (wafer) to obtain the surface energies at different points of the joint object of interest. One or more embodiments include a white light source (e.g., deformation measuring element 9103) and a mechanism (e.g., deformation measuring element 9103) to measure the surface height on 3D structure. One or more embodiments include the ability to adjust the humidity of the environment in which it is experimented. One or more embodiments include a mechanism (e.g., deformation measuring element 9103) to measure the Z-directional shift of the object (wafer) surface using a white light interferometry measurement method as the razor blade moves.

One or more embodiments include a test method with multiple insertions of the cleaving element 9113. One or more embodiments include determining surface energy, γ, using a deflection profile via differential equations. One or more embodiments include calibration through beam bending or 3D simulations (e.g., Finite Element Analysis). One or more embodiments include batch testing of multiple samples (e.g., strips 301). One or more embodiments include continuous or stepped measurement of the interfacial fracture strength across the sample length. One or more embodiments are not restricted to rectangular beams. Differential equations were used in deriving the equation (1) used to determine fracture strength. Differential equations can be used for determining fracture strength for samples of any shape, or finite-element analysis can be used where a neat analytical solution is not feasible. Furthermore, machine learning (ML) algorithms can be trained to determine fracture strength for various sample dimensions, shapes to accurately predict fracture strength using finite element simulations. Such trained ML models can be deployed in tools to determine fracture strength.

One or more embodiments do not use infrared light. One or more embodiments use light to which the sample is opaque. One or more embodiments scan only from the top and not the side. One or more embodiments include systems for temperature and humidity control to accurately study the impact of these parameters on fracture strength. One or more embodiments include introduction of a crack through other means such as, including but not limited to, wedge, pre-fabricated crack, sacrificial layer, low adhesion layer, foreign material, etc. One or more embodiments include crack propagation that can be achieved through applying a force using a fixture.

Although the overall test method and the apparatus that carries out the tests are novel, certain individual steps/elements required to implement aspects of the invention may utilize conventional semiconductor fabrication techniques and conventional semiconductor fabrication tooling. These techniques and tooling will already be familiar to one having ordinary skill in the relevant arts given the teachings herein. For example, the skilled artisan will be familiar with stepper devices. It is emphasized that while some individual steps are set forth herein, those steps are merely illustrative, and one skilled in the art may be familiar with several equally suitable alternatives that would be applicable.

It is to be appreciated that the various layers and/or regions shown in the accompanying figures may not be drawn to scale. Furthermore, one or more semiconductor layers of a type commonly used in such integrated circuit devices to be tested may not be explicitly shown in a given figure for ease of explanation. This does not imply that the semiconductor layer(s) not explicitly shown are omitted in the actual integrated circuit device.

Given the discussion thus far, it will be appreciated that, in general terms, an exemplary apparatus includes a stage 9107 configured to support a test piece. Also included are a crack propagating element positioned in relation to the stage; a deformation measuring element positioned above the stage; and a processor 9111 configured to control the stage 9107 and the deformation measuring element.

In a non-limiting example, the crack propagating element comprises a cleaving element 9113 and the deformation measuring element comprises a profilometer 9103 configured to determine deformation in the test piece, perpendicular to a plane of the stage, upon engagement of the cleaving element with the test piece.

In one or more embodiments, an edge 403 of the cleaving element 9113 is oriented so that it can cleave the test piece when the test piece is secured on the stage.

In one or more embodiments, a memory 9115 is coupled to the processor 9111, and the memory is configured to store instructions for operating the apparatus so as to facilitate any one, some, or all of the method steps described herein. The memory could, in some instances, be further configured to store insertion profiles of the cleaving element 9113.

One or more embodiments further including the test piece per se. In a non-limiting example, the test piece is a bonded sample, to be tested for bond strength, disposed on the stage 9107.

One or more embodiments further include a mechanism 9114 configured to relatively move the cleaving element towards a center 209 of the bonded sample 205 disposed on the stage 9107. “Relatively move” means the cleaving element moves towards the sample and/or the sample moves towards the cleaving element.

In one or more embodiments, the profilometer 9103 is an optical profilometer employing visible light.

One or more embodiments further include a humidity controller 9109 coupled to the processor 9111.

In at least some cases, a body of the cleaving element 9113 is parallel to the stage 9107.

The stage 9107 can include a mechanism 9110 for securing a bonded sample 205 that is positioned on the stage 9107.

The apparatus can further include a mechanism 9114 configured to move a tip 9112 of the cleaving element 9113 across the stage 9107.

One or more embodiments further include an alignment mechanism 9108 configured to align the test piece with the cleaving element 9113 when the test piece is disposed on the stage; the alignment mechanism 9108 is positioned adjacent to the stage 9107.

One or more embodiments do not use infrared light for measurement. One or more embodiments use light to which the sample is opaque (e.g., visible light). One or more embodiments scan only from the top and not the side of the test piece.

In accordance with further aspects of the invention, an exemplary method includes providing an apparatus such as was described. For example, the provided apparatus includes a stage 9107; a cleaving element 9113 positioned in relation to the stage; a deformation measuring element (e.g., profilometer 9103) positioned above the stage; and a processor 9111 configured to control the stage, the cleaving element, and the deformation measuring element. A further step includes securing a test piece to the stage. In further steps, the processor causes relative motion of the cleaving element towards the secured test piece for multiple insertions of the cleaving element into the secured test piece, until the secured test piece fractures; and he processor causes measurement, with the deformation measuring element, of a vertical height along at least a portion of a length of the secured test piece, to determine, for the multiple insertions, a crack tip location (see, e.g., FIGS. 2, 3) in the secured test piece.

In one or more embodiments, the secured test piece includes bonded portions to be cleaved along a bond line.

One or more embodiments further include determining a crack length as a difference between the crack tip location and an edge of the cleaving element.

One or more embodiments further include calculating fracture strength, wherein γ is fracture strength, t_{b} is blade thickness of the cleaving element, E is Young's modulus, t_{w} is wafer thickness, and L is crack length.

In one or more embodiments, the deformation measuring element does not use infrared light.

In one or more embodiments, the deformation measuring element uses light to which the secured test piece is opaque (e.g., visible light).

In a non-limiting example, the deformation measuring element comprises a profilometer, and further steps include scanning with the profilometer only from a top and not a side of the secured test piece.

Further exemplary steps include calculations to obtain γ. It is worth noting that testing is not limited to bond strength testing—in some cases, a unitary sample (e.g., underfill) could be split to measure cohesive facture strength instead of interfacial fracture strength (as in the case of a bonded sample).

Refer now to FIG. 12.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 200 to control an apparatus as described herein. Processor set 110 can implement processor 9111; memory 9115 can be implemented by elements 112, 113; and monitor 9117 can be one of the peripheral devices 114, for example.

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 12. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM.

Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101.

Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card.

Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141.

The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed.

The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. An apparatus comprising:
a stage configured to support a test piece;
a crack propagating element positioned in relation to the stage;
a deformation measuring element positioned above the stage; and
a processor configured to control the stage and the deformation measuring element.

2. The apparatus of claim 1, wherein the crack propagating element comprises a cleaving element and wherein the deformation measuring element comprises a profilometer configured to determine deformation in the test piece, perpendicular to a plane of the stage, upon engagement of the cleaving element with the test piece.

3. The apparatus of claim 2, wherein an edge of the cleaving element is oriented so that it can cleave the test piece when the test piece is secured on the stage.

4. The apparatus of claim 2, further including a memory coupled to the processor, the memory configured to store instructions for operating the apparatus to cause:
relative motion of the cleaving element towards the test piece when the test piece is secured on the stage for multiple insertions of the cleaving element into the secured test piece, until the secured test piece fractures; and
measurement, with the profilometer, of a vertical height along at least a portion of a length of the secured test piece, to determine, for the multiple insertions, a crack tip location in the secured test piece.

5. The apparatus of claim 2, further including the test piece, wherein the test piece comprises a bonded sample, to be tested for bond strength, disposed on the stage.

6. The apparatus of claim 5, further comprising a mechanism configured to relatively move the cleaving element towards a center of the bonded sample disposed on the stage.

7. The apparatus of claim 2, wherein the profilometer includes an optical profilometer employing visible light.

8. The apparatus of claim 2, further including a humidity controller coupled to the processor.

9. The apparatus of claim 2, wherein a body of the cleaving element is parallel to the stage.

10. The apparatus of claim 2, wherein the stage includes a mechanism for securing a bonded sample that is positioned on the stage.

11. The apparatus of claim 2, further comprising a mechanism configured to move a tip of the cleaving element across the stage.

12. The apparatus of claim 2, further comprising an alignment mechanism configured to align the test piece with the cleaving element when the test piece is disposed on the stage, the alignment mechanism positioned adjacent to the stage.

13. A method comprising:
providing an apparatus comprising:
a stage;
a cleaving element positioned in relation to the stage;
a deformation measuring element positioned above the stage; and
a processor configured to control the stage, the cleaving element, and the deformation measuring element;
securing a test piece to the stage;
the processor causing relative motion of the cleaving element towards the secured test piece for multiple insertions of the cleaving element into the secured test piece, until the secured test piece fractures; and
the processor causing measurement, with the deformation measuring element, of a vertical height along at least a portion of a length of the secured test piece, to determine, for the multiple insertions, a crack tip location in the secured test piece.

14. The method of claim 13, wherein the secured test piece includes bonded portions to be cleaved along a bond line.

15. The method of claim 13, further including determining a crack length as a difference between the crack tip location and an edge of the cleaving element.

16. The method of claim 15, further including calculating fracture strength:
$$γ = \frac{3 {t}_{b}^{2} {Et}_{w}^{3}}{32} {L}^{- 4}$$
wherein γ is fracture strength, t_{b} is blade thickness of the cleaving element, E is Young's modulus, t_{w} is wafer thickness, and L is crack length.

17. The method of claim 13, wherein the deformation measuring element does not use infrared light.

18. The method of claim 13, wherein the deformation measuring element uses light to which the secured test piece is opaque.

19. The method of claim 13, wherein the deformation measuring element comprises a profilometer, further comprising scanning with the profilometer only from a top and not a side of the secured test piece.

20. A computer program product for controlling an apparatus comprising:
a stage;
a cleaving element positioned in relation to the stage;
a deformation measuring element positioned above the stage; and
a processor configured to control the stage, the cleaving element, and the deformation measuring element;
the computer program product comprising:
one or more computer-readable storage media; and
program instructions stored on the one or more computer-readable storage media to perform operations comprising:
causing relative motion of the cleaving element towards the secured test piece for multiple insertions of the cleaving element into the secured test piece, until the secured test piece fractures; and
causing measurement, with the deformation measuring element, of a vertical height along at least a portion of a length of the secured test piece, to determine, for the multiple insertions, a crack tip location in the secured test piece.
